(19) United States
(12) Patent Application Publication
(10) Pub. No.: US 2014/0167725 A1
(43) Pub. Date: Jun. 19, 2014

(54) CURRENT CONTROL CIRCUIT AND METHOD

(71) Applicants: Huan-Chien Yang, New Taipei (TW); Shui-Mu Lin, Taichung (TW); Shei-Chie Yang, Taichung (TW); Ti-Ti Liu, Taipei (TW); Yung-Chun Chuang, Zhubei City (TW)

(72) Inventors: Huan-Chien Yang, New Taipei (TW); Shui-Mu Lin, Taichung (TW); Shei-Chie Yang, Taichung (TW); Ti-Ti Liu, Taipei (TW); Yung-Chun Chuang, Zhubei City (TW)

(73) Assignee: RICHTEK TECHNOLOGY CORPORATION, Chupei City (TW)

(21) Appl. No.: 14/043,550

(22) Filed: Oct. 1, 2013

Related U.S. Application Data
(60) Provisional application No. 61/738,696, filed on Dec. 18, 2012.

(51) Int. Cl. G05F 3/02

(52) U.S. Cl. CPC G05F 3/02
USPC 323/311

(57) ABSTRACT

The invention provides a current control circuit and a current control method. The current control circuit controls a current supplied to a current-controlled device according to a conduction control signal. The current control circuit includes: a conduction control switch coupled to the current-controlled device, for determining whether to conduct the current according to the conduction control signal; and a plurality of current control switches connected to one another in series and coupled to the conduction control switch, for controlling a magnitude of the current.

### CROSS REFERENCE

The present invention claims priority to U.S. 61/738696, filed on Dec. 18, 2012.

### BACKGROUND OF THE INVENTION

1. Field of Invention

The present invention relates to a current control circuit, especially a current control circuit using plural current control switches to reduce parasitic capacitive coupling effect. The present invention also provides a current control method to reduce parasitic capacitive coupling effect.

2. Description of Related Art

A current control circuit is often used for driving a current-controlled device such as a light emitting diode (LED). FIG. 1A shows a prior art current control circuit 10, which includes two switches: a conduction control switch M11 and a current control switch M12. The conduction control switch M11 is controlled by a conduction control signal Sc to determine whether to conduct or cutoff a current supplied to the LED, and the current control switch M12 controls a magnitude of the current in conduction. The conduction control switch M11 is an NMOS transistor and its source is coupled to a differential amplifier circuit Opa. The source voltage of the conduction control switch M11 is accurately controlled by the close loop design, so the current is accurate, but it has a drawback that the operation of the differential amplifier circuit Opa results in a longer response time (over 75 ns).

FIG. 1B shows another prior art current control circuit 20, wherein a conduction control signal Sc controls a conduction control switch M21 through a driving gate 21. Compared with FIG. 1A, the response time of the current control circuit 20 is shorter (about 30 ns) because it does not include a differential amplifier circuit Opa. However, the current control circuit 20 has the following drawback: as the conduction control switch M21 is just being turned on, because of the capacitive coupling effect, the charges at the node A will induce charges at the gate G22 of the current control switch M22 to cause a temporary overshoot of the gate voltage such that the current flowing through the conduction control switch M21 is incorrect, until the charges become balanced and stable. Therefore, the current control circuit 20 is less accurate in current precision control.

According to the above, neither the current control circuit 10 nor the current control circuit 20 can achieve both high precision and short response time in current control.

### SUMMARY OF THE INVENTION

In a perspective of the present invention, a current control circuit is provided for controlling a current supplied to a current-controlled device according to a conduction control signal, the current control circuit comprising: a conduction control switch coupled to the current-controlled device, for determining whether to conduct the current according to the conduction control signal; a plurality of current control switches connected with one another in series and coupled to the conduction control switch; and a plurality of operation switches, each operation switch having a first terminal for receiving a corresponding current control signal, and a second terminal for controlling a corresponding one of the current control switches, wherein the operation switches control a magnitude of the current supplied to the current-controlled device by controlling the conduction of the current control switches according to the current control signals.

In a preferable embodiment of the present invention, the conduction control switch is coupled between the current-controlled device and the current control switches, or the current control switches are coupled between the current-controlled device and the conduction control switch.

In a preferable embodiment, the current control switches are MOS transistors.

In a preferable embodiment of the present invention, a parasitic capacitor exists between a drain and a gate of each current control switch and another parasitic capacitor exists between the gate and a source of each current control switch; when the conduction control switch starts conducting the current, the current control switches are temporarily off to balance charges in the parasitic capacitors and afterward the current control switches are turned on.

In a preferable embodiment of the present invention, a parasitic capacitor exists between a drain and a gate of each current control switch and another parasitic capacitor exists between the gate and a source of each current control switch; when the conduction control switch stops conducting the current, the current control switches are temporarily on to balance charges in the parasitic capacitors, and afterward the current control switches are off.

In a preferable embodiment of the present invention, a parasitic capacitor exists between a drain and a gate of each current control switch and another parasitic capacitor exists between the gate and a source of each current control switch, and the current control circuit further comprises: a start-up circuit coupled to the current control switches for providing charges to the parasitic capacitors when the current control circuit is starting up or after the conduction control signal stays in a non-conducting status over a predetermined period of time.

In one preferable embodiment of the present invention, when the conduction control switch starts conducting the current, the operation switches are temporarily off such that the current control switches are temporarily not turned on, and afterward the operation switches are turned on.

In a preferable embodiment of the present invention, when the conduction control switch stops conducting the current, the operation switches are turned off but the current control switches are temporarily kept conductive, and afterward the current control switches are turned off.

In another preferable embodiment of the present invention, the start-up circuit includes a plurality of bias circuits respectively coupled to the gates of the current control switches.

In another perspective, the present invention also provides a current control method for a current control circuit which is coupled to a current-controlled device and includes a conduction control switch and a plurality of current control switches connected to one another in series and coupled to the conduction control switch, the conduction control switch receiving a conduction control signal to determine whether to conduct a current supplied to the current-controlled device, and the plurality of current control switches being for controlling a magnitude of the current, wherein each current control switch is a MOS transistor, and parasitic capacitors exist between a drain and a gate of the MOS transistor and exist between the gate and a source of the MOS transistor, the current control method comprising: conducting the conduction control switch according to the conduction control signal; balancing charges in the parasitic capacitors before conducting each current control switch; and conducting each current control switch.

In a preferable embodiment, the current control method further includes: providing charges to the parasitic capacitors when the current control circuit is starting up or after the conduction control signal stays in a non-conducting status over a predetermined period of time.

In a preferable embodiment, the current control method further includes: turning off the conduction control switch according to the conduction control signal; temporarily keeping each current control switch conductive for balancing the charges in the parasitic capacitors; and afterward, turning off the current control switches.

The objectives, technical details, features, and effects of the present invention will be better understood with regard to the detailed description of the embodiments below, with reference to the drawings.

### BRIEF DESCRIPTION OF THE DRAWINGS

FIGS. 1A and 1B show two prior art current control circuits.

FIG. 2A shows a preferable embodiment of the current control circuit according to the present invention.

FIGS. 2B-2D show the operation according to the present invention and illustrate how the parasitic capacitive coupling effect is reduced.

FIG. 3 shows another preferable embodiment of the current control circuit according to the present invention.

FIG. 4 shows yet another preferable embodiment of the current control circuit according to the present invention.

FIG. 5 shows another preferable embodiment of the current control circuit according to the present invention.

### DESCRIPTION OF THE PREFERRED EMBODIMENTS

The drawings as referred to throughout the description of the present invention are for illustrative purpose only, but not drawn according to actual scale. The orientation wordings in the description such as: above, under, left, or right are for reference with respect to the drawings, but not for limiting the actual product made according to the present invention.

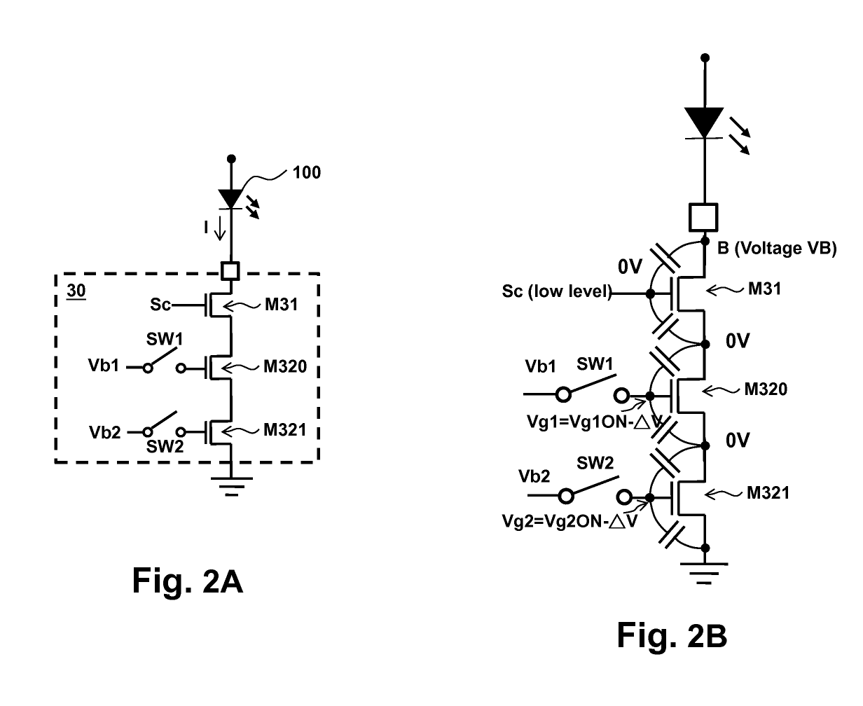

FIG. 2A shows an embodiment of the current control circuit 30 according to a perspective of the present invention, for controlling a current I supplied to a current-controlled device 100 (which is for example but not limited to the LED shown in figure) according to a conduction control signal Sc. The current control circuit 30 includes: a conduction control switch M31 coupled to the current-controlled device 100, for determining whether to conduct the current I according to the conduction control signal Sc; plural current control switches M320 and M321 connected to one another in series and coupled to the current-controlled device 100, for controlling a magnitude of the current I, wherein the current control switches M320 and M321 are respectively controlled by current control signals Vb1 and Vb2 through corresponding switches SW1 and SW2. The current control switches M320 and M321 for example can be MOS transistors (such as but not limited to the NMOS transistors shown in the figure). The current control signals Vb1 and Vb2 control the magnitude of the current I by controlling the conduction of the current control switches M320 and M321.

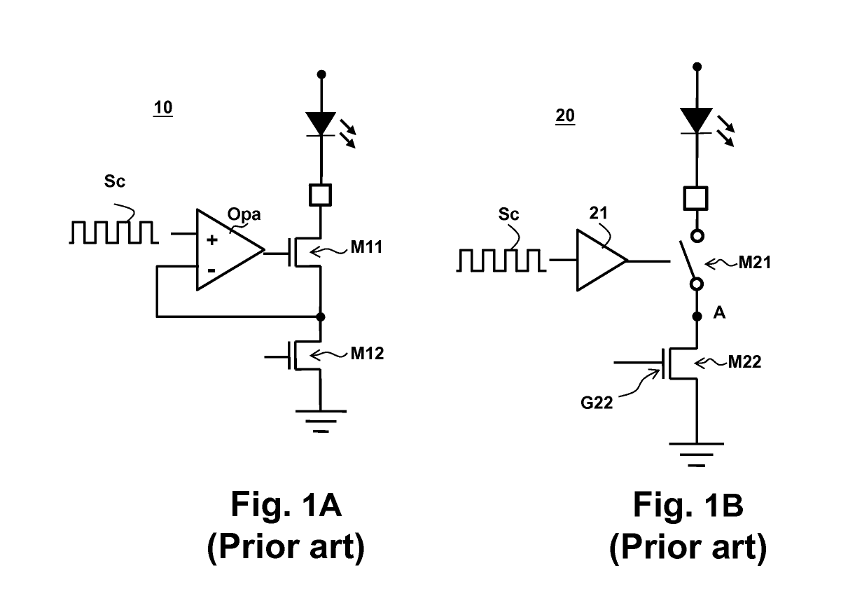

In comparison with the prior art shown in FIG. 1B, the plural current control switches M320 and M321 in the current control circuit 30 can reduce the inaccuracy in the prior art caused by the gate voltage overshoot of the current control switch as a result of a capacitive coupling effect. FIGS. 2B-2D illustrate how the present invention reduces the capacitive coupling effect to provide an accurate supplied current I. Referring to FIG. 2B, when the conduction control signal is at low level and the current control switches M320 and M321 are turned off, the voltage at the node B (marked as voltage VB) is at high level, and the drain voltages of the current control switches M320 and M321 are 0V. The gate voltages are respectively at the charges-balanced levels which have been achieved after the previous stage, that is, since the last turned-off of the conduction control switch M31. Because the switches SW1 and SW2 are turned off, the charges are retained at the gates of the current control switches M320 and M321. For simplicity and more illustrative, the gate voltages of the current control switches M320 and M321 at this time point are referred to respectively as (Vg1ON−ΔV) and (Vg2ON−ΔV), indicating that the charges at the gates of the current control switches M320 and M321 pre-charge or pre-discharge the gate voltages of the current control switches M320 and M321 to respective levels which are lower than the conduction voltages Vg1ON and Vg2ON by a voltage difference ΔV.

Referring to FIG. 2C, when the conduction control signal Sc conducts the conduction control switch M31, the node B and the node C are conducted. The voltage at node C increases to VB-I·Ron, wherein Ron is a conduction resistance of the conduction control switch M31, and I·Ron is a voltage drop across the conduction control switch M31. At this moment, the current control switches M320 and M321 are not turned on yet (i.e., the current control switches M320 and M321 are temporarily off because the switches SW1 and SW2 are not turned on yet), but the voltage at the node C induces a coupling effect to generate induced voltages at the gates Vg1 and Vg2 of the current control switches M320 and M321 (i.e., the charges are distributed in the parasitic capacitors in a balanced form). The response time to reach a charges-balanced state is short, because after the conduction control switch M31 is turned off in the previous stage, the gate voltages of the current control switches M320 and M321 are pre-charged or pre-discharged by coupling effect to respective levels which are only −ΔV from the conduction voltages (Vg1ON and Vg2ON), and when the conduction control switch M31 is turned on, the voltage difference caused by the coupling effect is ΔV, that is, the voltage increase ΔV caused by the coupling effect corresponds to the insufficient difference −ΔV, so it almost require no response time for the current to reach its accurate magnitude.

Afterward, the current control switches M320 and M321 are turned on (switches SW1 and SW2 are turned on), and the gate voltages Vg1 and Vg2 are already at proper levels, so there will not an overshoot. Besides, the cascade structure formed by the current control switches M320 and M321 increases an equivalent signal output resistance, such that any voltage variation at node B affects very little on the current I, and therefore the current I can be accurately controlled. The upper left part of FIG. 2C shows the level changes of node C and the gates Vg1 and Vg2.

Referring to FIG. 2D, when the conduction control signal Sc turns off the conduction control switch M31, the current control switches M320 and M321 are also turned off. Similar to FIG. 2B, the charges in the six parasitic capacitors are balanced. The upper left part of FIG. 2D shows the level changes of node C and the gates Vg1 and Vg2. In detail, when the switches SW1 and SW2 are just turned off, the current control switches M320 and M321 are temporarily kept conductive because the voltages at gates Vg1 and Vg2 are still at high level. When the conduction control signal Sc turns off the conduction control switch M31, the charges reach a balanced and stable state by the coupling effect. As the drain voltages of the current control switches M320 and M321 become 0V, the current control switches M320 and M321 are turned off, and their gate voltages are respectively maintained at (Vg1ON−ΔV) and (Vg2ON−ΔV).

To sum up, because the voltage variations at the gates of the current control switches M320 and M321 are only ΔV, the response time of the current control circuit is very quick.

The number of the current control switches is not limited to the number shown in the figure, and the number of two current control switches M320 and M321 is only for illustrative purpose. According to the practical need, the number of the current control switches can be increased.

In FIGS. 2A-2D, the conduction control switch M31 is coupled between the current-controlled device 100 and the current control switches M320 and M321, and this connection arrangement is only an example. In another embodiment, the current control switches M320 and M321 can be coupled between the current-controlled device 100 and the conduction control switch M31.

Referring to FIG. 2B and related description in the above, during a start-up stage wherein the current control circuit just starts operation, the six parasitic capacitors have not yet stored charges. Thus, when the voltage at node B increases, the response time for the charges stored in the six parasitic capacitors to reach a balanced and stable state is a little longer. To shorten the response time in the circuit start-up stage, a start-up circuit can be provided according to the present invention.

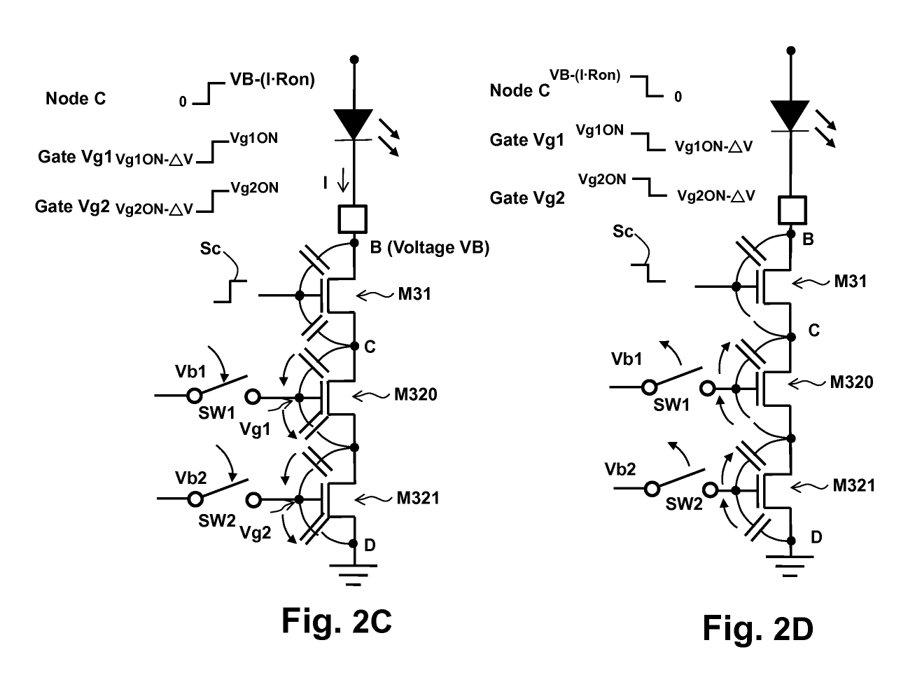

FIG. 3 shows another embodiment of the current control circuit 40 according to the present invention, which further includes a start-up circuit 41. The start-up circuit 41 is coupled to the gates of the current control switches M320 and M321. If the circuit is just started up and no charges are stored in the parasitic capacitors, or if the conduction control signal Sc stays at low level (taking low level for not conduction as an example) for a long time which exceeds a predetermined period of time such that the charges stored in the parasitic capacitors are lost, the start-up circuit 41 can provide charges to the gates of the current control switches M320 and M321, raising the gate voltages of the current control switches M320 and M321 to a predetermined level, so that the charges in the parasitic capacitors can reach and be stably balanced at a level higher than zero. After the circuit has been started up or as the conduction control signal Sc turns to high level, the response time of the circuit can be shortened because the charges in the parasitic capacitors are at already at proper levels. Note that the start-up circuit is not necessary and can be omitted when the response time at circuit start-up stage is not critical.

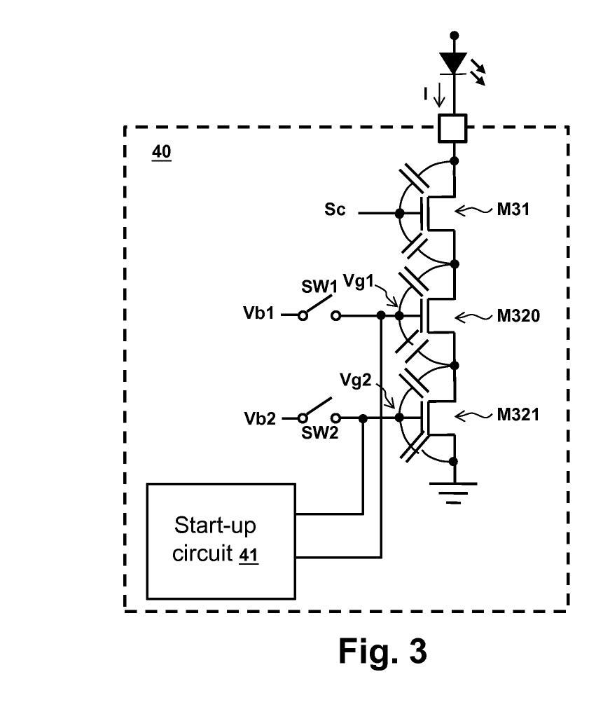

FIG. 4 shows an embodiment of the start-up circuit 41 of the present invention. The start-up circuit 41 includes two bias circuits 411 and 412 and corresponding switches Sw3 and SW4. The switches Sw3 and SW4 are turned on when bias voltages are needed for gates of the current control switches M320 and M321. If no bias voltage is needed, the switches SW3 and SW4 are turned off. The bias circuits 411 and 412 can be implemented in various forms; for example, the bias circuits 411 and 412 can be reference voltage generators or unit gain circuits as shown in the figure. The circuits compare the gate voltages Vg1 and Vg2 of the current control switches M320 and M321 with reference signals Vb1_ref and Vb2_ref respectively, to generate output signals which are sent to the gates Vg1 and Vg2 of the current control switches M320 and M321, wherein the reference signals Vb1_ref and Vb2_ref can be but not limited to be corresponding to current control signals Vb1 and Vb2. The negative terminals of the unit gain circuits are shown to be coupled to the gates Vg1 and Vg2 in the figure, but in another embodiment, the negative terminal of a unit gain circuit can be coupled to a signal input terminal such that an open loop circuit is formed; this arrangement also can provide charges to the parasitic capacitors during circuit start-up stage.

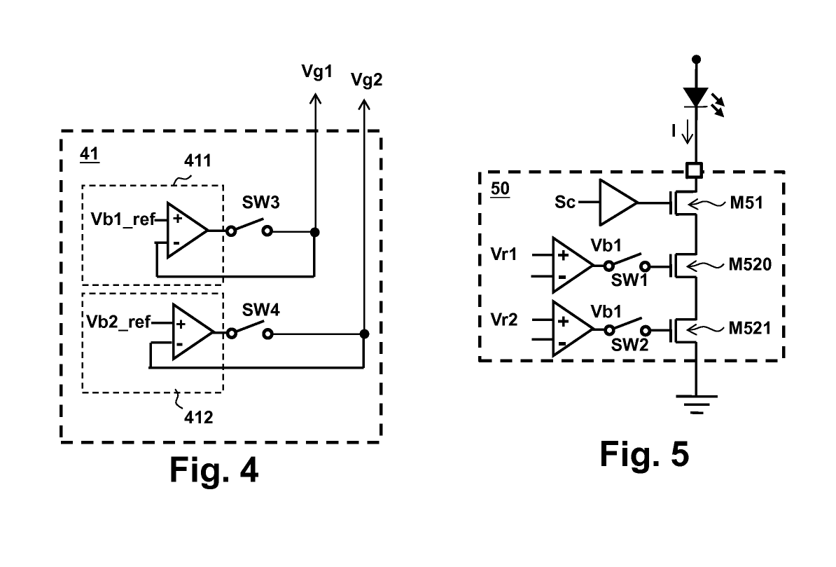

FIG. 5 shows an embodiment of the current control circuit 50 according to the present invention. Compared with FIG. 2A, the embodiment of FIG. 5 shows that: 1. A driver circuit can be coupled between the conduction control signal Sc and the conduction control switch M51; the driver circuit converts the conduction control signal Sc to a signal having a higher amplitude for better driving the conduction control switch M51. 2. The current control signals Vb1 and Vb2 can be generated by open or close loops. As shown in the figure, the current control signals Vb1 and Vb2 can be generated by differential amplifier circuits according to reference signals Vr1 and Vr2. The other input terminal of the differential amplifier circuit can be an open loop connection (for example, connected to a voltage node for receiving a signal to decide the current control signal Vb1 or Vb2) or a close loop connection (for example, connected to the gates of the current control switches M520 and M521; in this case the reference signals Vr1 and Vr2 will respectively decide the current control signals Vb1 and Vb2). The open or close loop arrangement can be decided as dsired.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. For example, a circuit or device which does not affect the primary function of the overall circuit can be inserted between any two circuits or devices shown to be in direction connection in the figures and embodiments. For another example, the positive and negative terminals of the differential amplifier circuit are interchangeable, with corresponding modification of the related subsequent circuit processing the output signal. The NMOS transistor shown in the embodiment can be replaced by a PMOS transistor. Therefore, the scope of the present invention should include all such modifications and equivalents. An embodiment or a claim of the present invention does not need to attain or include all the objectives, advantages or features described in the above. The abstract and the title are provided for assisting searches and not to be read as limitations to the scope of the present invention.

What is claimed is:

1. A current control circuit for controlling a current supplied to a current-controlled device according to a conduction control signal, the current-controlled device being coupled to the current control circuit, the current control circuit comprising:
a conduction control switch coupled to the current-controlled device, for determining whether to conduct the current according to the conduction control signal;
a plurality of current control switches connected with one another in series and coupled to the conduction control switch; and
a plurality of operation switches, each operation switch having a first terminal for receiving a corresponding current control signal, and a second terminal for controlling a corresponding one of the current control switches, wherein the operation switches control a magnitude of the current supplied to the current-controlled device by controlling the conduction of the current control switches according to the current control signals.

2. The current control circuit of claim 1, wherein the conduction control switch is coupled between the current-controlled device and the current control switches, or the current control switches are coupled between the current-controlled device and the conduction control switch.

3. The current control circuit of claim 1, wherein the current control switches are MOS transistors.

4. The current control circuit of claim 3, wherein a parasitic capacitor exists between a drain and a gate of each current control switch and another parasitic capacitor exists between the gate and a source of each current control switch; when the conduction control switch starts conducting the current, the current control switches are temporarily off to balance charges in the parasitic capacitors and afterward the current control switches are turned on.

5. The current control circuit of claim 3, wherein a parasitic capacitor exists between a drain and a gate of each current control switch and another parasitic capacitor exists between the gate and a source of each current control switch; when the conduction control switch stops conducting the current, the current control switches are temporarily on to balance charges in the parasitic capacitors, and afterward the current control switches are off.

6. The current control circuit of claim 3, wherein a parasitic capacitor exists between a drain and a gate of each current control switch and another parasitic capacitor exists between the gate and a source of each current control switch, and the current control circuit further comprises: a start-up circuit coupled to the current control switches for providing charges to the parasitic capacitors when the current control circuit is starting up or after the conduction control signal stays in a non-conducting status over a predetermined period of time.

7. The current control circuit of claim 6, wherein the start-up circuit includes a plurality of bias circuits respectively coupled to the gates of the current control switches.

8. The current control circuit of claim 1, wherein when the conduction control switch starts conducting the current, the operation switches are temporarily off such that the current control switches are temporarily not turned on, and afterward the operation switches are turned on.

9. The current control circuit of claim 1, wherein when the conduction control switch stops conducting the current, the operation switches are turned off but the current control switches are temporarily kept conductive, and afterward the current control switches are turned off.

10. A current control method for a current control circuit which is coupled to a current-controlled device and includes a conduction control switch and a plurality of current control switches connected to one another in series and coupled to the conduction control switch, the conduction control switch receiving a conduction control signal to determine whether to conduct a current supplied to the current-controlled device, and the plurality of current control switches being for controlling a magnitude of the current, wherein each current control switch is a MOS transistor, and parasitic capacitors exist between a drain and a gate of the MOS transistor and exist between the gate and a source of the MOS transistor, the current control method comprising:
conducting the conduction control switch according to the conduction control signal;
balancing charges in the parasitic capacitors before conducting each current control switch; and
conducting each current control switch.

11. The current control method of claim 10, further comprising: providing charges to the parasitic capacitors when the current control circuit is starting up or after the conduction control signal stays in a non-conducting status over a predetermined period of time.

12. The current control method of claim 10, further comprising:
turning off the conduction control switch according to the conduction control signal;
temporarily keeping each current control switch conductive for balancing the charges in the parasitic capacitors; and
afterward, turning off the current control switches.
